(19) United States
(12) Patent Application Publication
(10) Pub. No.: US 2015/0147055 A1
(43) Pub. Date: May 28, 2015

(54) OPTICAL SYSTEM, OPTICAL DEVICE, AND OPTICAL CONNECTION METHOD

(71) Applicant: NEC CORPORATION, Tokyo (JP)

(72) Inventor: Katsuyuki Mino, Tokyo (JP)

(73) Assignee: NEC CORPORATION, Tokyo (JP)

(21) Appl. No.: 14/400,853

(22) PCT Filed: Feb. 28, 2013
(86) PCT No.: PCT/JP2013/055399

§ 371 Date: Nov. 13, 2014

(30) Foreign Application Priority Data
May 18, 2012 (JP) 2012-114026

(51) Int. Cl. H04Q 11/00; H04B 10/032

(52) U.S. Cl. CPC H04Q 11/0005; H04B 10/032
USPC 398/1

(57) ABSTRACT

An optical system includes: an optical module that sends and receives an optical signal; an optical switch that optically connects to the optical module; and a plurality of optical connectors that optically connect to the optical switch. The optical switch selectively connects at least one of the plurality of optical connectors to the optical module.

### TECHNICAL FIELD

The present invention relates to an optical system which includes optical connectors that optically connect optical fibers, an optical device, and an optical connection method.

### BACKGROUND ART

An example of an optical system, an optical device, and an optical connection method is disclosed in Patent Document 1. The optical system, the optical device, and the optical connection method of Patent Document 1 include an optical connector adaptor that is inserted between a pair of optical connectors such that it can be attached or detached to connect them.

### PRIOR ART DOCUMENTS

### Patent Documents

[Patent Document 1] Japanese Unexamined Patent Application, First Publication No. 2004-69821

### SUMMARY OF THE INVENTION

### Problem to be Solved by the Invention

In recent years, in an optical system which includes optical devices connected via optical connectors, if dirt attaches to an optical connector for some reason during operation, there is a possibility that the optical connector will be damaged. Increasing the output level of an optical module (for example, optical amplifier module) or the like in an optical device, is a factor that can increase this possibility. Furthermore, since the instances of a plurality of optical modules being installed in the same optical device have been increasing, it is presumed that the cases of optical connectors in optical devices being damaged will increase henceforth.

For a system that includes an optical connector that optically connects optical fibers, an optical device, and an optical connection method, as shown in FIG. 6 there is an optical system 500 in which a first optical device 501 (also referred to simply as optical device 501) and a second optical device 502 (also referred to simply as optical device 502) are connected via optical connectors. The first optical device 501 includes an optical module 503. The optical module 503 includes a monitor collection circuit 504. The optical module 503 is optically connected to an optical connector 506 via an optical fiber 505. The second optical device 502 includes an optical module 507. The optical module 507 includes a monitor collection circuit 508. A monitor device 509 is connected to the monitor collection circuits 504 and 508. One optical connector 511 of an optical fiber 510 is optically connected to the optical connector 506 via an optical adaptor (not shown in the figure). The other optical connector 512 of the optical fiber 510 is optically connected to an optical fiber 513 of the optical module 507 of the second optical device 502. In such an optical system 500, if the optical connector 506 is optically connected to the optical connector 511 via the optical adaptor while there is a contaminant such as dirt is attached, the connection loss becomes excessive, or the reflection characteristics are not obtained, which sometimes causes damage. In that case in such an optical system 500, the damaged first optical device 501 must be taken to a manufacturing facility. Moreover, in the manufacturing facility, the optical module 503 installed in the optical device 501 must be removed for re-splicing or the like. Accordingly, in such a system 500, in the case where the optical connector 506 is damaged, operation is interrupted, causing a drop in the operation efficiency, which wastes a lot of time, effort, and expense.

Patent Document 1 proposes a method for solving the above-described problems of the optical system 500.

As shown in FIG. 7, an optical system 600 according to Patent Document 1 includes a first optical device 601 (also referred to simply as optical device 601) and a second optical device 602 (also referred to simply as optical device 602). The first optical device 601 includes an optical module 603. The optical module 603 includes a monitor collection circuit 604. The optical module 603 is connected to an optical connector 606 via an optical fiber 605. The second optical device 602 includes an optical module 607. The optical module 607 includes a monitor collection circuit 608. A monitor device 609 is connected to the monitor collection circuits 604 and 608. In the first optical device 601, the optical connector 606 is optically connected to an optical connector 611 of an optical connector adaptor 610. An optical connector 612 of the optical connector adaptor 610 is optically connected to an optical connector 614 optically connected to an optical fiber 613. Furthermore, an optical connector 615 optically connected to the optical fiber 613 is optically connected to the optical fiber 616 of the optical module 607 of the second optical device 602. Using this construction, in the optical system 600 according to Patent Document 1, in the case where the optical connector 612 of the first optical device 601 is damaged, the optical connector 612 and the optical connector 611 of the optical connector adaptor 610 are removed, and the optical connector 606 is directly connected to the optical connector 614. The optical system 600 according to Patent Document 1 can avoid the time, effort, and expense of removing the optical module 503 of the optical device 501 to take it to a manufacturing facility unlike the case of the above-described optical system 500. However, in the optical system 600, when the optical connector 606 is directly connected to the optical connector 614 for operation, in the case where the optical connector 606 is damaged, the optical module 603 must be taken to a manufacturing facility. Accordingly, the construction of the optical system 600 according to Patent Document 1 only can deal with a case of one instance of damage. That is, it cannot deal with a case of a plurality of instances of damage to optical connectors.

The present invention has been made in order to solve the above-described problem. An exemplary object of the present invention is to provide an optical system, an optical device, and an optical connection method that can improve productivity significantly by handling a plurality of instances of damage to optical connectors.

### Means for Solving the Problem

An optical system according to an exemplary aspect of the present invention includes: an optical module that sends and receives an optical signal; an optical switch that optically connects to the optical module; and a plurality of optical connectors that optically connect to the optical switch. The optical switch selectively connects at least one of the plurality of optical connectors to the optical module.

An optical device according to an exemplary aspect of the present invention includes: an optical module that sends and receives an optical signal; an optical switch that optically connects to the optical module; and a plurality of optical connectors that optically connect to the optical switch and optically connect to the optical switch The optical switch selectively connects at least one of the plurality of optical connectors to the optical module.

An optical connection method includes: optically and selectively connecting at least one of a plurality of optical connectors to an optical module that receives and sends an optical signal.

### Effect of the Invention

According to an optical system, an optical device, and an optical connection method of the present invention, it is possible to deal with a plurality of instances of damage to optical connectors, so that productivity can be improved significantly.

### BRIEF DESCRIPTION OF THE DRAWINGS

FIG. 1 is a block diagram of an optical system of a first exemplary embodiment of the present invention.

FIG. 2 is a block diagram of an optical system of a second exemplary embodiment of the present invention.

FIG. 3 is a block diagram of an optical system of a third exemplary embodiment of the present invention.

FIG. 4 is a block diagram of an optical system of a fourth exemplary embodiment of the present invention.

FIG. 5 is a flow chart to explain the control operations of the optical system shown in FIG. 4.

FIG. 6 is a block diagram of a related optical system.

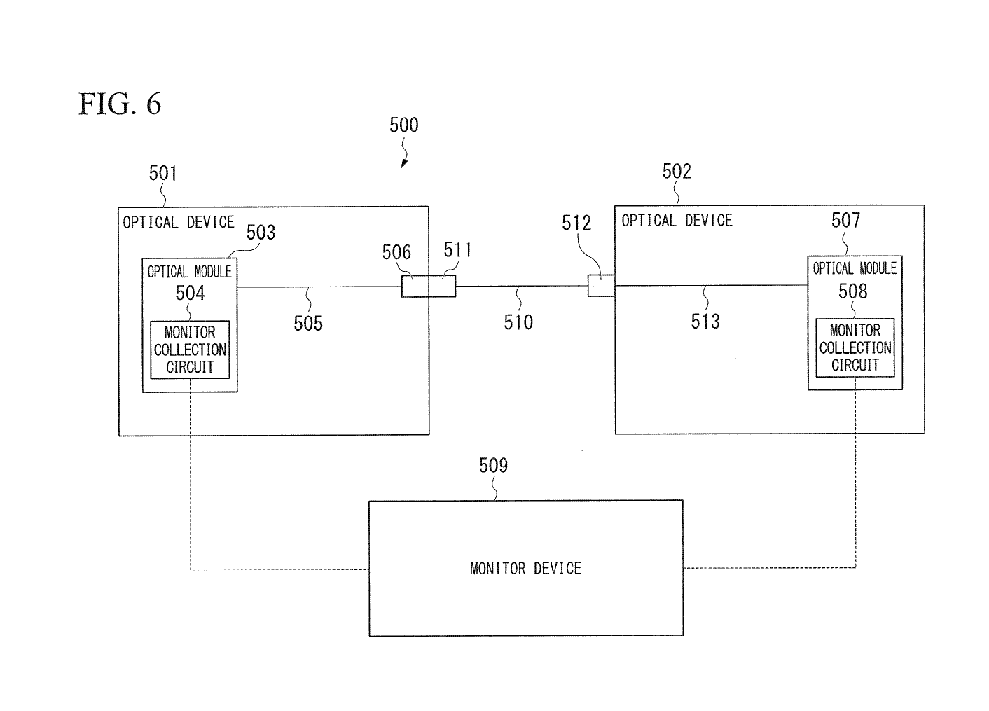

FIG. 7 is a block diagram of an optical system disclosed in Patent Document 1.

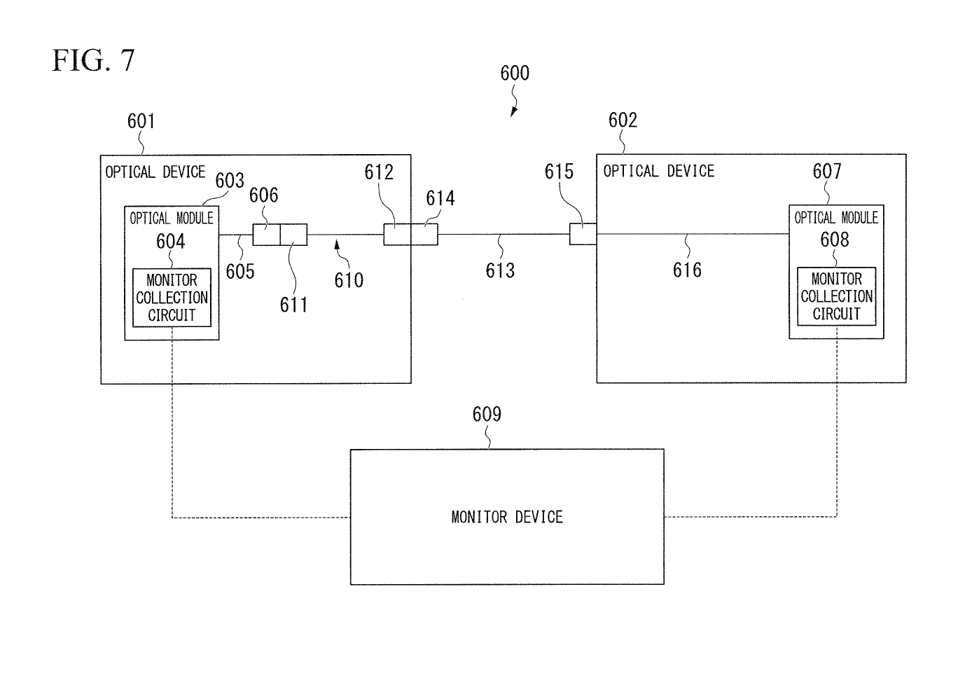

### EMBODIMENTS FOR CARRYING OUT THE INVENTION

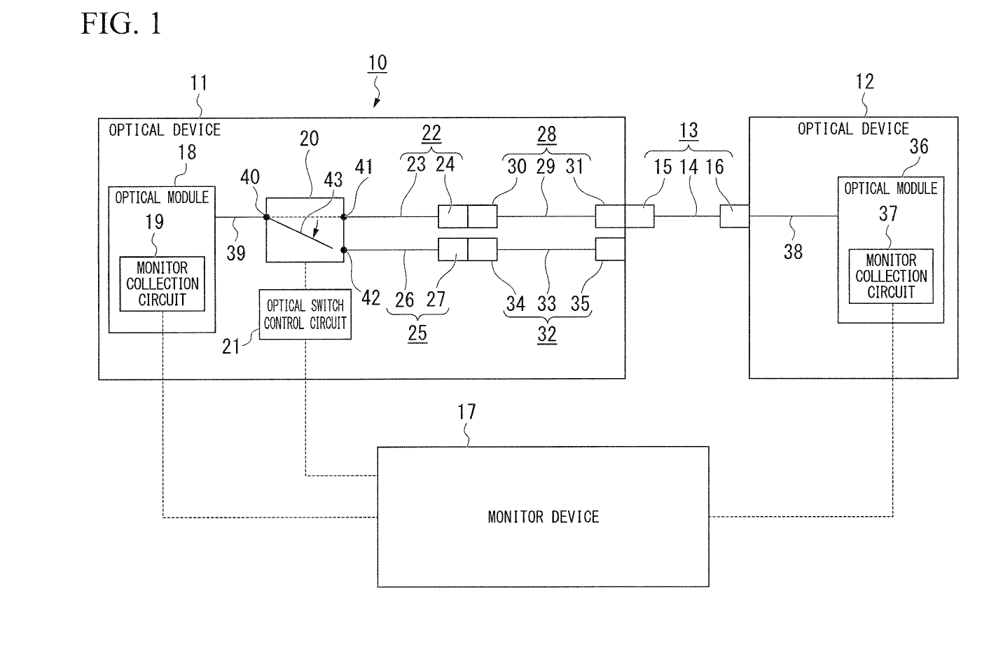

Hereunder is a description of an optical system, an optical device, and an optical connection method according to a plurality of exemplary embodiments of the present invention with reference to the drawings. As shown in FIG. 1, an optical system 10 of a first exemplary embodiment of the present invention includes an optical device 11, an optical device 12, an optical cable 13, and a monitor device 17. The optical cable 13 has an optical fiber 14, an optical connector 15 optically connected to one end portion of the optical fiber 14, and an optical connector 16 optically connected to the other end portion of the optical fiber 14.

The optical device 11 includes an optical module 18, an optical switch 20, an optical switch control circuit 21, and an optical cable 22. The optical module 18 incorporates a monitor collection circuit 19. The optical cable 22 has an optical fiber 23 and an optical connector 24 optically connected to one end portion of the optical fiber 23.

Furthermore, the optical device 11 includes an optical cable 25 and an optical cable 28. The optical cable 25 has an optical fiber 26 and an optical connector 27 optically connected to one end portion of the optical fiber 26. The optical cable 28 has an optical fiber 29, an optical connector 30 optically connected to one end portion of the optical fiber 29, and an optical connector 31 optically connected to the other end portion of the optical fiber 29.

Moreover, the optical device 11 includes an optical cable 32. The optical cable 32 has an optical fiber 33, an optical connector 34 optically connected to one end portion of the optical fiber 33, and an optical connector 35 optically connected to the other end portion of the optical fiber 33.

The optical device 12 includes an optical module 36 having a monitor collection circuit 37. An optical fiber 38 is optically connected to an optical module 36. An end portion of the optical fiber 38 is optically connected to the optical connector 16.

An optical fiber 39 is optically connected to the optical module 18. The optical fiber 39 is optically connected to a port 40 of the optical switch 20. A port 41 of the optical switch 20 is optically connected to the optical fiber 23 of the optical cable 22. A port 42 of the optical switch 20 is optically connected to the optical fiber 26 of the optical cable 25.

The optical switch 20 has a moving contact 43 optically connected to the optical fiber 39 via the port 40. The moving contact 43 switches between the port 41 and the port 42 by the optical switch control circuit 21. When the moving contact 43 of the optical switch 20 switches to the port 41, the optical fiber 39 of the optical module 18 is optically connected to the optical fiber 23 of the optical cable 22. When the moving contact 43 of the optical switch 20 switches to the port 42, the optical fiber 39 of the optical module 18 is optically connected to the optical fiber 26 of the optical cable 25.

The optical connector 30 of the optical cable 28 is detachably mounted on the optical connector 24 of the optical cable 22. The optical connector 31 of the optical cable 28 can be detachably mounted on the optical connector 15. Similarly, the optical connector 34 of the optical cable 32 is detachably mounted on the optical connector 27 of the optical cable 25. The optical connector 35 of the optical cable 32 can be detachably mounted on the optical connector 15.

The monitor collection circuit 19 obtains a state signal by constantly collecting the optical state of the optical module 18, and supplies the state signal to the monitor device 17. Similarly, the monitor collection circuit 37 obtains a state signal by constantly collecting the optical state of the optical module 36, and supplies the state signal to the monitor device 17. The monitor device 17 constantly monitors the state signal of the optical module 18 supplied from the monitor collection circuit 19, and the state signal of the optical module 36 supplied from the monitor collection circuit 37.

In the case where the deviation of either of the state signals exceeds a predetermined value, the monitor device 17 supplies a drive signal to the optical switch control circuit 21. According to the drive signal, the optical switch control circuit 21 switches the moving contact 43 of the optical switch 20 from the port 41 to the port 42, or from the port 42 to the port 41.

Next is a description of an optical connection method. A case is described in which damage occurs in the optical connector 31 while the optical system 10 is operating in a state in which the moving contact 43 of the optical switch 20 is connected to the port 41, and the optical connector 31 of the optical cable 28 is optically connected to the optical connector 15. In this case, the value of the state signal from the monitor collection circuit 19 exceeds a predetermined value with respect to the value of the state signal from the monitor collection circuit 37. In response, the optical switch control circuit 21 switches the moving contact 43 of the optical switch 20 from the port 41 on the currently connected side to the port 42 on the opposite, unconnected side. As a result, the connection state of the optical connection circuit, is switched: from the port 40 of the optical switch 20 to the port 42 of the optical switch 20 to the optical fiber 26 to the optical connector 27 to the optical connector 34 to the optical fiber 33 to the optical connector 35. Then the optical connector 35 is optically connected to the optical connector 15. By so doing, the optical system 10 forms an optical connection circuit without interposing the damaged optical connector 31. At this time, after the damage is repaired, the optical cable 28 that had the damaged optical connector 31 is restored to the previous state by the optical connector 30 being optically connected to the optical connector 24.

Next is a description of a case in which damage occurs in the optical connector 35 while the optical system 10 is operating in a state in which the moving contact 43 of the optical switch 20 is switched to the port 42. In this case, the value of the state signal from the monitor collection circuit 19 exceeds a predetermined value with respect to the value of the state signal from the monitor collection circuit 37. In response, the optical switch control circuit 21 switches the moving contact 43 of the optical switch 20 from the port 42 on the currently connected side to the port 41 on the opposite, unconnected side. As a result, the connection state of the optical connection circuit is switched: from the port 40 of the optical switch 20 to the port 41 of the optical switch 20 to the optical fiber 23 to the optical connector 24 to the optical connector 30 to the optical fiber 29 to the optical connector 31. By so doing, the optical system 10 forms an optical connection circuit without interposing the damaged optical connector 35. At this time, after the damage is repaired, the optical cable 32 that had the damaged optical connector 35 is restored to the previous state by the optical connector 34 being optically connected to the optical connector 27.

Next, a case is described in which damage recurs in the optical connector 31 while the optical system 10 is operating in a normal state in which the moving contact 43 of the optical switch 20 is connected to the port 41, and the optical connector 31 of the optical cable 28 is optically connected to the optical connector 15. In this case, the value of the state signal from the monitor collection circuit 19 exceeds a predetermined value with respect to the value of the state signal from the monitor collection circuit 37. In response, the optical switch control circuit 21 switches the moving contact 43 of the optical switch 20 from the port 41 on the currently connected side to the port 42 on the opposite, unconnected side. As a result, the connection state of the optical connection circuit is switched: from the port 40 of the optical switch 20 to the port 42 of the optical switch 20 to the optical fiber 26 to the optical connector 27 to the optical connector 34 to the optical fiber 33 to the optical connector 35. Then the optical connector 35 is optically connected to the optical connector 15. By so doing, the optical system 10 forms an optical connection circuit without interposing the damaged optical connector 31. At this time, after the damage is repaired, the optical cable 28 that had the damaged optical connector 31 is restored to the previous state by the optical connector 30 being optically connected to the optical connector 24.

Here, a case is assumed in which the monitor device 17 determines that the value of the state signal from the monitor collection circuit 19 exceeds a predetermined value with respect to the value of the state signal from the monitor collection circuit 37. In this case, instead of using the optical switch control circuit 21, the moving contact 43 of the optical switch 20 may be switched manually from the port 41 to the port 42, or from the port 42 to the port 41.

As described above, according to the optical system 10 of the first exemplary embodiment, even if damage occurs in the optical connector 31 or the optical connector 35, an optical connection can be formed without the damaged optical connector 31 or optical connector 35 being interposed. As a result, it can deal with a plurality of instances of damage to optical connectors, so that it is possible to improve productivity significantly.

Furthermore, according to the optical system 10, the monitor device 17 can process information based on the optical information from the monitor collection circuits 19 and 37, and the optical switch control circuit 21 can control the optical switch 20 automatically. As a result, it is possible to reduce the load on an operator.

Moreover, according to the optical system 10, the moving contact 43 of the optical switch 20 can be switched manually based on the optical information from the monitor collection circuits 19 and 37. As a result, there is an advantage in cost without using a complicated circuit and mechanism.

Furthermore, according to the optical system 10, it is possible to switch the moving contact 43 of the optical switch 20 from the currently connected side to the opposite, unconnected side by the optical switch control circuit 21. As a result, it is possible to change the optical connection circuit automatically even in the case where the optical system 10 does not have an automatic output stopping function.

Moreover, according to the optical system 10, the optical connector 30 of the optical cable 28 can be attached to and detached from the optical connector 24 of the optical cable 22, and also the optical connector 31 can be attached to and detached from the optical connector 15. Furthermore, the optical connector 34 of the optical cable 32 can be attached to and detached from the optical connector 27 of the optical cable 25, and also the optical connector 35 can be attached to and detached from the optical connector 15. Accordingly, attaching and detaching at the time of damage can be performed easily.

Furthermore, according to the optical device 11, even if damage occurs in the optical connector 31 or the optical connector 35, an optical connection circuit can be formed without the damaged optical connector 31 or optical connector 35 being interposed. As a result, it can deal with a plurality of instances of damage to the optical connector, so that it is possible to improve the productivity significantly.

In addition, according to the optical connection method, even if damage occurs in the optical connector 31 or the optical connector 35, an optical connection can be made without the damaged optical connector 31 or optical connector 35 being interposed. As a result, it can deal with a plurality of instances of damage to the optical connector, so that it is possible to improve the productivity significantly.

Next is a description of an optical system, an optical device, and an optical connection method according to a second exemplary embodiment of the present invention. In the following exemplary embodiments, the descriptions associated with structural elements identical or functionally similar to those in the first exemplary embodiment are simplified or omitted by using identical symbols or equivalent symbols in the figures.

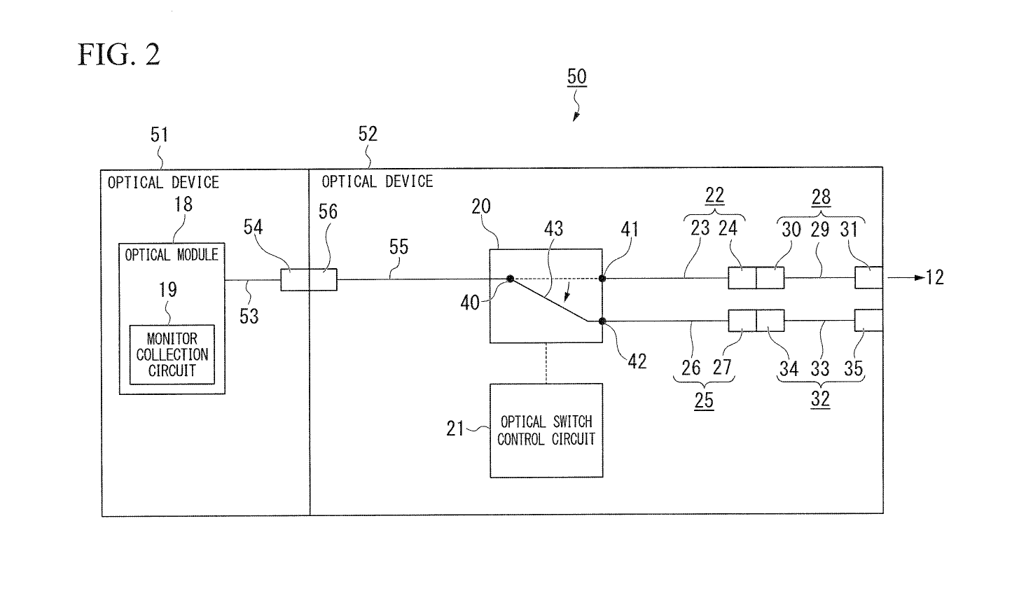

As shown in FIG. 2, an optical system 50 of the second exemplary embodiment has a construction that is divided into an optical device 51 and an optical device 52. The optical device 51 has an optical module 18. The optical device 52 has an optical switch 20, an optical switch control circuit 21, an optical cable 22, an optical cable 25, an optical cable 28, and an optical cable 32. The optical device 51 has the optical module 18, an optical fiber 53 optically connected to the optical module 18, and an optical connector 54 optically connected to the optical fiber 53. The optical device 52 has an optical fiber 55 optically connected to a port 40 of the optical switch 20, and an optical connector 56 optically connected to the optical fiber 55. The optical connector 54 can be detachably mounted on the optical connector 56.

According to the optical system 50 of the second exemplary embodiment, by attaching the optical connector 56 of the optical device 52 to the optical connector 54 of the optical device 51, the optical device 52 can be attached to the optical device 51 later using a simple operation.

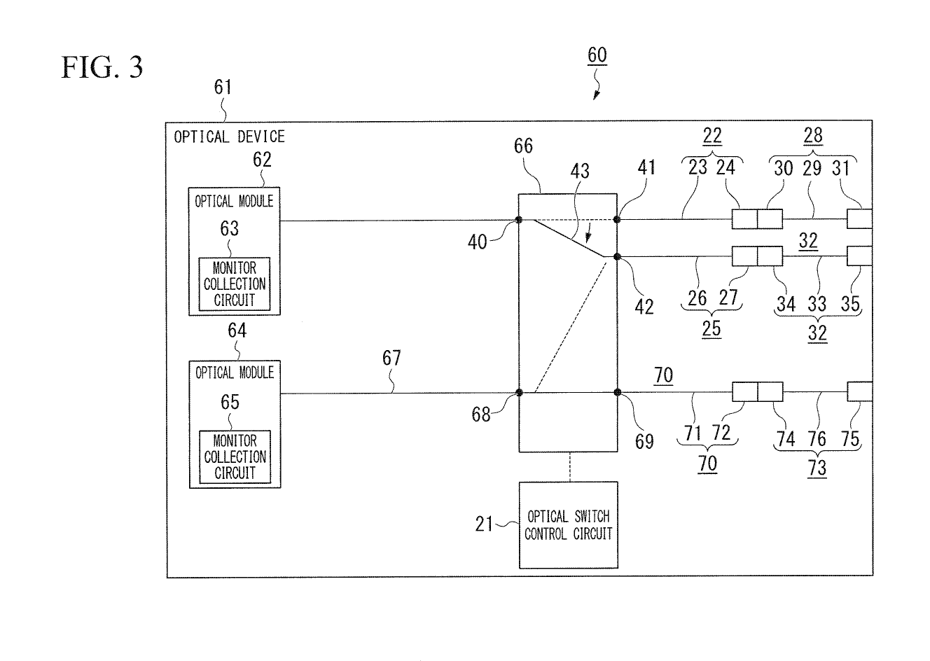

Next is a description of an optical system, an optical device, and an optical connection method according to a third exemplary embodiment of the present invention. As shown in FIG. 3, an optical system 60 of the third exemplary embodiment includes an optical device 61 including two optical modules being an optical module 62 and an optical module 64. The optical module 62 has a monitor collection circuit 63. The optical module 64 has a monitor collection circuit 65. An optical fiber 67 is optically connected to the optical module 64. The optical fiber 67 is optically connected to a port 68 of an optical switch 66. An optical fiber 71 of an optical cable 70 is optically connected to a port 69 of the optical switch 66. An optical cable 73 has an optical fiber 76, an optical connector 74 optically connected to one end portion of the optical fiber 76, and an optical connector 75 optically connected to the other end portion of the optical fiber 76. The optical connector 74 of the optical cable 73 is optically connected to an optical connector 72 of the optical cable 70. The port 68 is optically connected to the port 69. The port 68 is optically connected to the port 42 selectively.

According to the optical system 60 of the third exemplary embodiment, the optical cable 73, which is not used at a normal time, can be shared by both of the optical module 62 and the optical module 64. As a result, there is further advantage in cost.

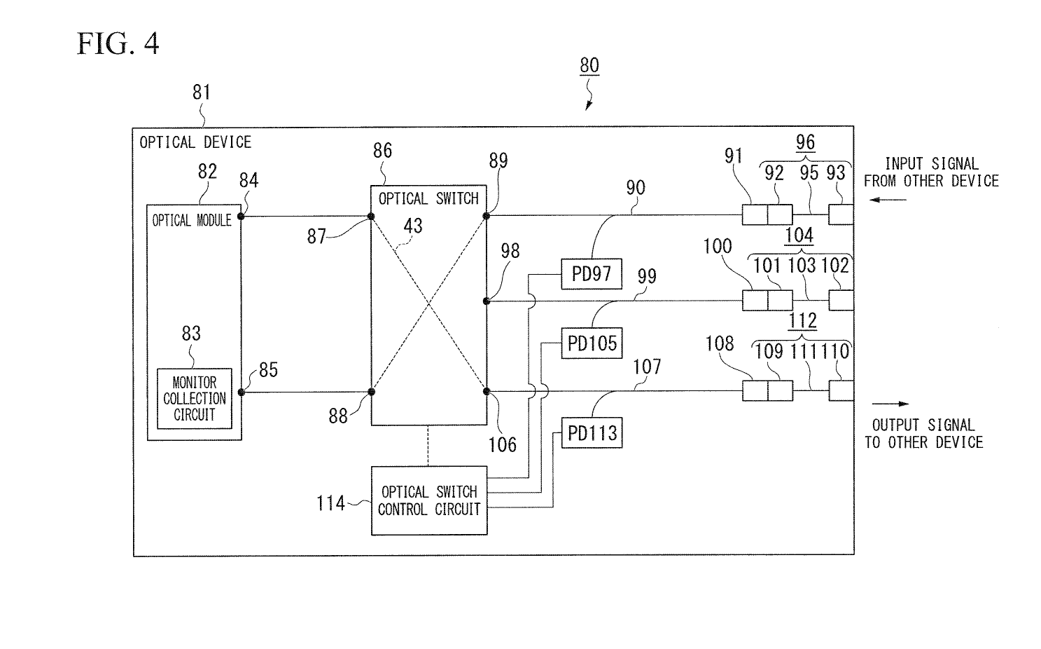

Next is a description of an optical system, an optical device, and an optical connection method according to a fourth exemplary embodiment of the present invention. As shown in FIG. 4, an optical system 80 of the fourth exemplary embodiment includes an optical device 81. The optical device 81 includes an optical module 82 and an optical switch 86. The optical module 82 has a monitor collection circuit 83, a port 84, and a port 85. The optical switch 86 has a port 87, a port 88, a port 89, and a port 106. The port 84 is optically connected to the port 87 of the optical switch 86. The port 85 is optically connected to the port 88 of the optical switch 86.

The port 89 of the optical switch 86 is one input side for a signal from another optical device (external optical device). An optical fiber 90 is connected to the port 89. The optical fiber 90 is optically connected to an optical connector 91. The optical connector 91 is connected to an optical connector 92. The optical connector 92 is optically connected to an optical fiber 95. An optical detector (photodiode) PD97 is optically connected to the optical fiber 90.

A port 98 of the optical switch 86 is the other input side for a signal from the other optical device. An optical fiber 99 is connected to the port 98. An optical connector 100 is optically connected to the optical fiber 99. The optical connector 100 is connected to an optical connector 101. The optical connector 101 is optically connected to an optical fiber 103. An optical detector PD105 is optically connected to the optical fiber 99.

The port 106 of the optical switch 86 is an output side for a signal to the other optical device. An optical fiber 107 is connected to the port 106. An optical connector 108 is optically connected to the optical fiber 107. The optical connector 108 is connected to an optical connector 109. The optical connector 109 is optically connected to an optical fiber 111. An optical detector PD113 is optically connected to the optical fiber 107.

The optical detectors PD97, PD105, and PD113 are each electrically connected to an optical switch control circuit 114.

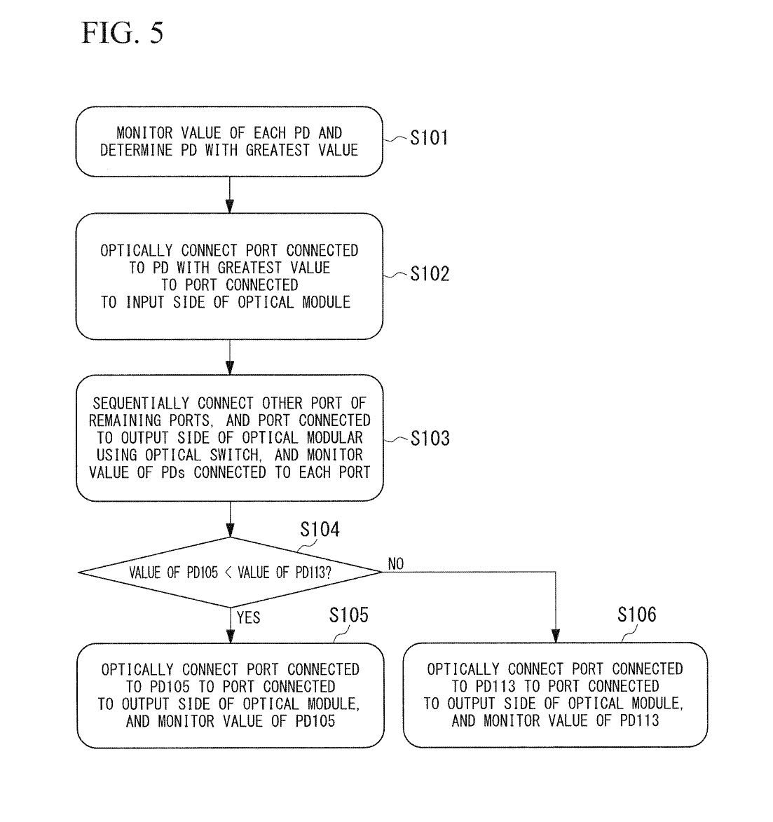

Next is a description of an optical connection method of the optical system 80. As shown in FIG. 5, firstly, the optical switch control circuit 114 monitors the values of each of the optical detectors PD97, PD105, and PD113, and determines which optical detector detects the greatest value (S101). Here, in the case where the optical detector PD97 has the greatest value, the optical switch control circuit 114 identifies the port 89 of the optical switch 86 to which the optical detector PD97 is connected. Then, the optical switch control circuit 114 optically connects the port 89 of the optical switch 86, which is connected to the port 87, to the port 88 connected to the input side of the optical module 82 (S102).

Next, the optical switch control circuit 114 sequentially connects port 98 and port 106, other than port 89, to the port 87 which is connected to the output side of the optical module 82. At this time, the optical switch control circuit 114 monitors the values of the optical detectors PD105 and PD113 which are connected to the port 98 and the port 106 respectively (S103). Next, the optical switch control circuit 114 compares the value of the optical detector PD105 and the value of the optical detector PD113 (S104). At this time, in the case where the value of the optical detector PD105 is less than the value of the optical detector PD113, it connects the port 98 and the port 87 which is connected to the output side of the optical module 82, and monitors the value of the optical detector PD105 connected to the port 98 (S105). On the other hand, in the case where the value of the optical detector PD105 is greater than the value of the optical detector PD113, it connects the port 106 and the port 87 which is connected to the output side of the optical module 82, and monitors the value of the optical detector PD113 connected to the port 106 (S106).

In this manner, based on the value of the optical detector PD105 and the value of the optical detector PD113, the port to which an output signal is connected is determined from the one whose value is lower (the one without Fresnel reflection due to an optical connector). Accordingly, by optically connecting one port among the ports 98 and 106 which transmits an output signal to another device, and the port 87 by the optical switch control circuit 114, then even in a case where the connection of input and output connectors to the optical module 82 is incorrect, it is not necessary to reconnect the optical connector.

According to the optical system 80 of the fourth exemplary embodiment, even in the case where the connection of input and output connectors to the optical module 82 is incorrect, it is possible to operate the optical module 82 normally without reconnecting the optical connector.

The optical system, the optical device, and the optical connection method of the present invention are not limited to the above-described exemplary embodiments, and any appropriate change, improvement and the like is possible.

This application is based upon and claims the benefit of priority from Japanese patent application No. 2012-114026, filed on May 18, 2012, the disclosure of which is incorporated herein in its entirety by reference.

### INDUSTRIAL APPLICABILITY

As described above, according to the optical system, the optical device, and the optical connection method of the present invention, it is possible to improve productivity significantly by dealing with a plurality of instances of damage to an optical connector. As a result of the above, it is possible to reduce the load on an operator significantly. Accordingly, the industrial applicability is high.

### REFERENCE SYMBOLS

10 Optical system
11 Optical device
15 Optical connector
16 Optical connector
17 Monitor device
18 Optical module
19 Monitor collection circuit
20 Optical switch
21 Optical switch control circuit
24 Optical connector
27 Optical connector
30 Optical connector
31 Optical connector
34 Optical connector
35 Optical connector
36 Optical module
37 Monitor collection circuit
50 Optical system
51 Optical device
52 Optical device
54 Optical connector
56 Optical connector
60 Optical system
61 Optical device
62 Optical module
63 Monitor collection circuit
64 Optical module
65 Monitor collection circuit
72 Optical connector
74 Optical connector
75 Optical connector
80 Optical system
81 Optical device
82 Optical module
83 Monitor collection circuit
86 Optical switch
91 Optical connector
92 Optical connector
93 Optical connector
100 Optical connector
101 Optical connector
102 Optical connector
108 Optical connector
109 Optical connector
110 Optical connector
114 Optical switch control circuit
PD97 Optical detector
PD105 Optical detector
PD113 Optical detector

1. An optical system comprising:
an optical module that sends and receives an optical signal;
an optical switch that optically connects to the optical module; and
a plurality of optical connectors that optically connect to the optical switch,
the optical switch selectively connecting at least one of the plurality of optical connectors to the optical module.

2. The optical system according to claim 1, further comprising:
a monitor collection circuit that collects an optical characteristic of the optical module, and outputs information of the optical characteristic; and
a monitor device that switches, by means of the optical switch, a connection between the optical module and the plurality of optical connectors based on the information from the monitor collection circuit.

3. The optical system according to claim 2, further comprising:
a plurality of monitor collection circuits that include the monitor collection circuit;
and the monitor device switches, by means of the optical switch, the connection between the optical module and the plurality of optical connectors based on a difference in information from the plurality of monitor collection circuits.

4. The optical system according to claim 1, wherein
The optical device includes a first optical device and a second optical device,
the first optical device includes the optical module, the optical switch, and the plurality of optical connectors,
Wherein one of the plurality of optical connectors is detachably attached to the second optical device.

5. The optical system according to claim 4, further comprising an optical switch control circuit that controls an operation of the optical switch.

6. The optical system according to claim 4, wherein the optical module includes a plurality of optical modules.

7. The optical system according to claim 1, further comprising an optical detector that is connected to the optical switch and provided on a side of the optical connector.

8. An optical device comprising:
an optical module that sends and receives an optical signal;
an optical switch that optically connects to the optical module; and
a plurality of optical connectors that optically connect to the optical switch,
the optical switch selectively connecting at least one of the plurality of optical connectors to the optical module.

9. An optical connection method comprising:
optically and selectively connecting at least one of a plurality of optical connectors to an optical module that receives and sends an optical signal.
